(19) United States
(12) Patent Application Publication
(10) Pub. No.: US 2026/0186430 A1
(43) Pub. Date: Jul. 2, 2026

(54) ELECTROPHOTOGRAPHIC PHOTORECEPTOR, PROCESS CARTRIDGE, AND IMAGE FORMING APPARATUS

(71) Applicant: KYOCERA DOCUMENT SOLUTIONS INC., OSAKA (JP)

(72) Inventors: RYOHEI YAMASAKI, OSAKA (JP); TETSUYA SENDA, OSAKA (JP)

(21) Appl. No.: 19/424,141

(22) Filed: Dec. 18, 2025

(30) Foreign Application Priority Data
Dec. 27, 2024 (JP) 2024-232135

(51) Int. Cl. G03G 5/06; G03G 5/047; G03G 5/05; G03G 5/10; G03G 5/14; G03G 21/00; G03G 21/18

(52) U.S. Cl. CPC G03G 5/06145; G03G 5/047; G03G 5/0564; G03G 5/0696; G03G 5/10; G03G 5/14; G03G 21/0011; G03G 21/1814; G03G 2215/0409

(57) ABSTRACT

An electrophotographic photoreceptor is used in an image forming apparatus using a non-magnetic one-component pulverized toner. The electrophotographic photoreceptor includes: an undercoat layer provided on a conductive base; and a photosensitive layer in which a charge generating layer and a charge transporting layer are stacked in order on the undercoat layer. The undercoat layer includes a thermosetting resin including an alkyd resin and a melamine resin, and a titanium oxide particle. The charge transporting layer includes a binder resin including a polycarbonate resin or a polyarylate resin, and a hole transporting agent including a compound represented by the general formula (1).

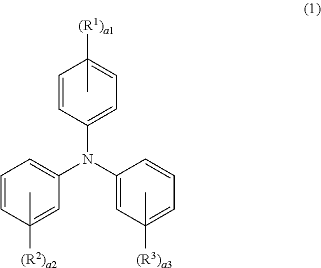

### CROSS-REFERENCE TO RELATED PATENT APPLICATION

This application claims the benefit of Japanese Priority Patent Application JP 2024-232135 filed Dec. 27, 2024, the entire contents of which are incorporated herein by reference.

### FIELD OF THE DISCLOSURE

The present disclosure relates to an electrophotographic photoreceptor that is used in an image forming apparatus using a non-magnetic one-component pulverized toner, a process cartridge, and an image forming apparatus.

### BACKGROUND OF THE DISCLOSURE

In general, in an image forming apparatus, a toner used to develop an electrostatic latent image on a photoreceptor surface is classified by its components into (1) a magnetic two-component toner formed of a magnetic toner and a carrier, (2) a non-magnetic two-component toner formed of a non-magnetic toner and a carrier, (3) a non-magnetic one-component toner formed of a non-magnetic toner, and (4) a magnetic one-component toner formed of a magnetic toner. Further, the toner is also classified by its production method into a polymerized toner generated by a polymerization method and a pulverized toner generated by a pulverization method.

In recent years, in the field of color printers for electrophotography, development has progressed on image forming apparatuses using a non-magnetic one-component pulverized toner as a model having characteristics such as compact size, low cost, and maintenance-free operation.

However, in the image forming apparatus using a non-magnetic one-component pulverized toner, a problem arises where a phenomenon in which a poorly charged toner adheres to the white background portion (i.e., an unexposed portion) of the image, known as “fog”, occurs due to the decrease in the toner's chargeability, degrading the image quality. In this regard, there is a technology to stabilize the toner's chargeability by adhering inorganic fine particles to the surface of toner particles.

### SUMMARY OF THE DISCLOSURE

According to an embodiment of the present disclosure, there is provided an electrophotographic photoreceptor that is used in an image forming apparatus using a non-magnetic one-component pulverized toner.

The electrophotographic photoreceptor includes: a conductive base; an undercoat layer provided on the conductive base; and a photosensitive layer provided on the undercoat layer.

The photosensitive layer includes a charge generating layer and a charge transporting layer.

The undercoat layer includes a thermosetting resin and a titanium oxide particle, the thermosetting resin including an alkyd resin and a melamine resin.

The charge transporting layer includes a binder resin and a hole transporting agent, the binder resin including at least one of a polycarbonate resin or a polyarylate resin, the hole transporting agent including a compound represented by the following general formula (1).

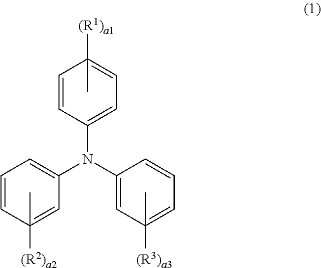

In the formula, R¹, R², and R³ each independently represent an alkyl group having 1 to 8 carbon atoms, an alkoxy group having 1 to 8 carbon atoms, or a group represented by the following formula (I), formula (II), or formula (III), and at least one or more of R¹, R², and R³ represent an alkyl group having 1 to 8 carbon atoms or an alkoxy group having 1 to 8 carbon atoms, and a1, a2, and a3 each independently represent an integer of 0 or more and 5 or less.

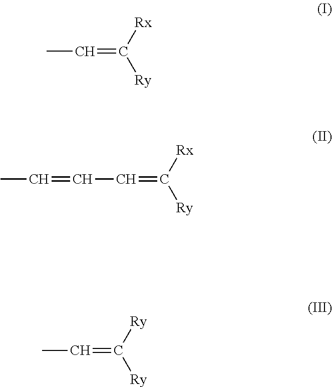

In the formula (I), the formula (II) and the formula (III), Rx each independently represent a hydrogen atom, an alkyl group having 1 to 8 carbon atoms, an alkoxy group having 1 to 8 carbon atoms, or a phenyl group which may be substituted with an alkyl group having 1 to 8 carbon atoms, and Ry each independently represent a phenyl group which may be substituted with an alkyl group having 1 to 8 carbon atoms or a phenyl group which may be substituted with an alkoxy group having 1 to 8 carbon atoms.

A process cartridge according to an embodiment of the present disclosure includes the above electrophotographic photoreceptor.

An image forming apparatus according to an embodiment of the present disclosure includes: an image carrier; a charging device that charges a surface of the image carrier; an exposure device that exposes the charged surface of the image carrier to form an electrostatic latent image on the surface of the image carrier; a development device that supplies a toner to the surface of the image carrier to develop the electrostatic latent image as a toner image; and a transfer device that transfers the toner image from the image carrier to a to-be-transferred body, the image carrier being the above electrophotographic photoreceptor.

### BRIEF DESCRIPTION OF THE DRAWINGS

FIG. 1 is a partial cross-sectional view of an electrophotographic photoreceptor that is an example of an electrophotographic photoreceptor according to an embodiment of the present disclosure.

FIG. 2 is a diagram showing an example of an image forming apparatus according to a second embodiment of the present disclosure.

FIG. 3 is a diagram showing a partial configuration of the development device shown in FIG. 2.

FIG. 4 is a diagram showing an overview of a measuring apparatus for the frictional charge amount.

### DETAILED DESCRIPTION OF THE EXEMPLARY EMBODIMENTS

Embodiments of the present disclosure will be described below in detail. Note that the present disclosure is not limited to the configurations of the following embodiments, and various modifications can be made to the configurations of the following embodiments as appropriate within the technical idea of the present disclosure. Further, a “general formula” and a “chemical formula” are collectively referred to as a “formula”. The phrase “each independently” in the description of the formula means that they may indicate the same group or different groups.

In the following, an alkyl group having 1 to 8 carbon atoms, an alkyl group having 1 or more and 6 or less carbon atoms, an alkyl group having 1 or more and 4 or less carbon atoms, an alkyl group having 1 or more and 3 or less carbon atoms, an alkoxy group having 1 to 8 carbon atoms, an alkoxy group having 1 or more and 6 or less carbon atoms, and an alkoxy group having 1 or more and 3 or less carbon atoms each have the following meanings, unless otherwise specified.

The alkyl group having 1 to 8 carbon atoms, the alkyl group having 1 or more and 6 or less carbon atoms, the alkyl group having 1 or more and 4 or less carbon atoms, and the alkyl group having 1 or more and 3 or less carbon atoms are each linear or branched chain and unsubstituted. Examples of the alkyl group having 1 to 8 carbon atoms include a methyl group, an ethyl group, an n-propyl group, an isopropyl group, an n-butyl group, a sec-butyl group, a tert-butyl group, an n-pentyl group, an isopentyl group, a neopentyl group, a 1,2-dimethylpropyl group, a hexyl group, a heptyl group, and an octyl group. Examples of the alkyl group having 1 or more and 6 or less carbon atoms include examples having 1 to 6 carbon atoms of the examples of the alkyl group having 1 to 8 carbon atoms. Examples of the alkyl group having 1 or more and 4 or less carbon atoms include examples having 1 to 4 carbon atoms of the examples of the alkyl group having 1 to 8 carbon atoms. Examples of the alkyl group having 1 or more and 3 or less carbon atoms include examples having 1 to 3 carbon atoms of the examples of the alkyl group having 1 to 8 carbon atoms.

The alkoxy group having 1 to 8 carbon atoms and the alkoxy group having 1 or more and 6 or less carbon atoms are each linear or branched chain and unsubstituted. Examples of the alkoxy group having 1 to 8 carbon atoms include a methoxy group, an ethoxy group, an n-propoxy group, an isopropoxy group, an n-butoxy group, a sec-butoxy group, a tert-butoxy group, an n-pentoxy group, an isopentoxy group, a neopentoxy group, a hexyloxy group, a heptyloxy group, and an octyloxy group. Examples of the alkoxy group having 1 or more and 6 or less carbon atoms include examples having 1 to 6 carbon atoms of the examples of the alkoxy group having 1 to 8 carbon atoms.

### First Embodiment: Electrophotographic Photoreceptor

### [Overall Configuration of Electrophotographic Photoreceptor]

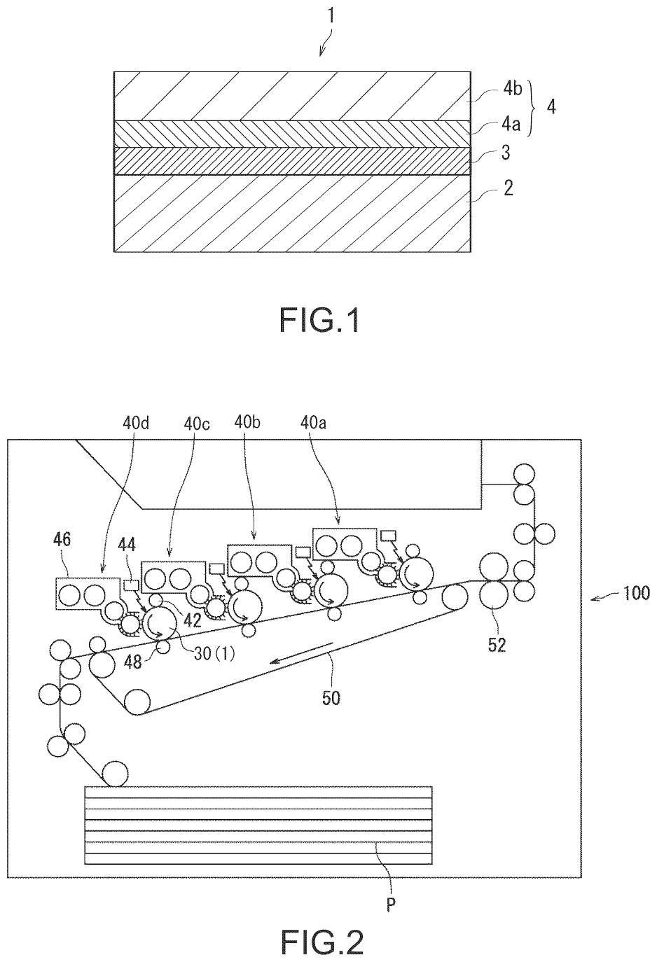

An electrophotographic photoreceptor according to an embodiment of the present disclosure is used in an image forming apparatus using a non-magnetic one-component pulverized toner. FIG. 1 is a partial cross-sectional view of an electrophotographic photoreceptor 1 according to the embodiment of the present disclosure (hereinafter, referred to as a photoreceptor 1 in some cases). As shown in FIG. 1, the photoreceptor 1 includes a conductive base 2, an undercoat layer 3 provided on the conductive base 2, and a photosensitive layer 4 provided on the undercoat layer 3. The photosensitive layer 4 includes a charge generating layer 4a and a charge transporting layer 4b. As shown in FIG. 1, in the photoreceptor 1 according to the present disclosure, typically, no protective layer is provided on the photosensitive layer 4 and a toner directly adheres to the surface of the specific charge transporting layer 4b described below in detail in order to stabilize the toner's chargeability. That is, the charge transporting layer 4b is favorably the top surface layer.

The photoreceptor 1 according to the embodiment of the present disclosure is characterized by the configurations of the undercoat layer 3 and the charge transporting layer 4b, which will be described below.

The undercoat layer 3 according to the present disclosure is characterized by including a thermosetting resin and titanium oxide, the thermosetting resin including an alkyd resin and a melamine resin. In general, the undercoat layer includes various resins including thermoplastic resins as a main component, and has an electrical blocking function that prevents charge injection from the conductive base 2 by further including a metal oxide particle or the like. In the undercoat layer 3 according to the present disclosure, adopting the specific thermosetting resin as a resin allows high charge retention to be achieved. This suppresses the adhesion of the toner to the unexposed portion of the toner, thereby suppressing the occurrence of fog.

Next, the charge transporting layer 4b according to the present disclosure is characterized by including a binder resin and a hole transporting agent, the binder resin including at least one of a polycarbonate resin or a polyarylate resin, the hole transporting agent including a compound represented by the following general formula (1).

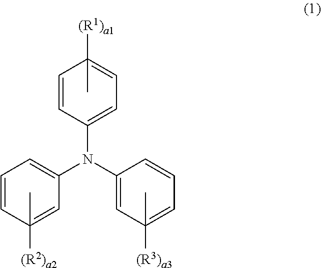

In the general formula (1), R¹, R², and R³ each independently represent an alkyl group having 1 to 8 carbon atoms, an alkoxy group having 1 to 8 carbon atoms, or a group represented by the following formula (I), formula (II), or formula (III), and at least one or more of R¹, R², and R³ represent an alkyl group having 1 to 8 carbon atoms or an alkoxy group having 1 to 8 carbon atoms. a1, a2, and a3 each independently represent an integer of 0 or more and 5 or less.

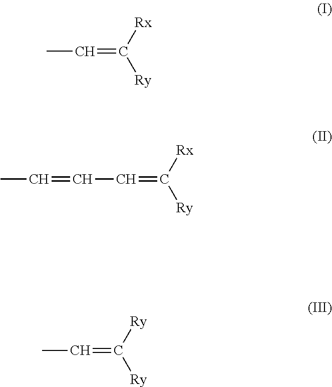

In the formula (I), the formula (II), and the formula (III), Rx each independently represent a hydrogen atom, an alkyl group having 1 to 8 carbon atoms, an alkoxy group having 1 to 8 carbon atoms, or a phenyl group which may be substituted with an alkyl group having 1 to 8 carbon atoms, and Ry each independently represent a phenyl group which may be substituted with an alkyl group having 1 to 8 carbon atoms or a phenyl group which may be substituted with an alkoxy group having 1 to 8 carbon atoms. In the formula (III), two Ry may be the same as or different from each other.

When the charge transporting layer 4b includes the specific charge transport agent as well as the binder resin, the toner's chargeability is stabilized. Specifically, when the surface of this photosensitive layer 4 (typically, the charge transporting layer 4b) and a toner are rubbed, the toner tends to exhibit a frictional charge amount of −15 μQ/g or less, making the toner more likely to be negatively charged and achieving the toner's charge stability.

Further, the synergistic effect achieved by combining the photosensitive layer 4 including the specific charge transporting layer 4b and the specific undercoat layer 3, i.e., the synergistic effect of the photoreceptor's high charge retention and the toner's charge stability, makes it difficult for the toner to adhere to the unexposed portion even during continuous printing and easier for the toner to adhere to the exposed portion, thereby reducing the occurrence of fog more effectively.

Further, the pulverized toner used in the present disclosure refers to an irregularly shaped toner having a circularity of 0.90 or less. When such a pulverized toner is used in an image forming apparatus, variations in electrical properties occur, the toner's chargeability is reduced, and fog is likely to occur. However, according to the electrophotographic photoreceptor 1 according to the present disclosure, it is possible to suppress the occurrence of fog effectively.

Further, using the non-magnetic toner used in the present disclosure it is difficult to form a uniform layer of the toner on the development roller by the magnetic force of the magnetic material. Therefore, it is necessary to form a thin toner layer having a constant thickness by causing the toner to come into contact with a blade (see a regulating blade 400 described below). For this reason, when using the non-magnetic toner, friction between the blade and the toner causes fine pulverization, leading to degradation of the toner and making the toner's chargeability more likely to be reduced. However, according to the photoreceptor according to the present disclosure1, it is possible to suppress the occurrence of fog more effectively.

According to such an electrophotographic photoreceptor 1 according to the present disclosure, it is possible to provide an electrophotographic photoreceptor capable of suppressing image defects due to fog even in an image forming apparatus using a non-magnetic one-component pulverized toner. Further, particularly, the electrophotographic photoreceptor 1 according to the present disclosure is favorably exposed by an inexpensive light-emitting diode (LED) from the viewpoint of lowering prices. Further, the photoreceptor 1 according to the embodiment of the present disclosure is favorably used in an image forming apparatus adopting a “direct transfer method” of transferring the toner image on the photoreceptor surface directly to a medium without an intermediate transfer belt, from the viewpoints of miniaturization and lowering prices.

Even when using an existing improved toner, the photoreceptor's chargeability gradually decreases during continuous printing, making it easier for the toner to adhere to the unexposed portion and making fog more likely to occur. For this reason, a means to suppress image defects due to fog is desired. On the other hand, according to the present disclosure, it is possible to provide an electrophotographic photoreceptor capable of suppressing image defects due to fog in an image forming apparatus using a non-magnetic one-component pulverized toner, a process cartridge, and an image forming apparatus.

Detailed configurations of the photoreceptor 1 according to the embodiment of the present disclosure will be described.

### [Detailed Configurations of Electrophotographic Photoreceptor]

### (Conductive Base 2)

The conductive base 2 according to the present disclosure is not particularly limited as long as at least the surface thereof is formed of a material having conductivity. An example of the conductive base 2 is the conductive base 2 formed of a material having conductivity. Another example of the conductive base 2 is the conductive base 2 covered with a material having conductivity. Examples of the material having conductivity include aluminum, iron, copper, tin, platinum, silver, vanadium, molybdenum, chromium, cadmium, titanium, nickel, palladium, and indium. Two or more materials having conductivity may be combined and used as an alloy (more specifically, an aluminum alloy, stainless steel, brass, or the like). As the material having conductivity, aluminum and an aluminum alloy are favorable because the charge transfer from the photosensitive layer 4 to the conductive base 2 is favorable. The shape of the conductive base 2 is appropriately selected in accordance with the structure of the image forming apparatus. Examples of the shape of the conductive base 2 include a sheet shape and a drum shape. Further, the thickness of the conductive base 2 is appropriately selected in accordance with the shape of the conductive base 2.

### (Undercoat Layer 3)

### Thermosetting Resin

A thermosetting resin including an alkyd resin and a melamine resin is typically a mixed resin obtained by combining an alkyd resin with a melamine resin as a cross-linking agent from the viewpoints of electrical properties, deposition properties, and the like, and the mixing mass ratio of the alkyd resin to the melamine resin (alkyd resin: melamine resin) can be appropriately selected in accordance with the purpose.

### Titanium Oxide Particle

The mass ratio of the titanium oxide particles included in the undercoat layer 3 to the thermosetting resin included in the undercoat layer 3 is, for example, 1 or more and 4 or less. The thickness of the undercoat layer 3 is, for example, 0.1 μm or more and 5 μm or less.

The titanium oxide particle may be subjected to surface treatment. The surface treatment of the titanium oxide particle may be performed once or a plurality of times (e.g., twice). Examples of the surface treatment agent used for the surface treatment of the titanium oxide particle include alumina, silica, and an organosilicon compound (e.g., polysiloxane, more specifically, methylhydrogenpolysiloxane).

Other inorganic particles or organic particles other than the titanium oxide particle may be included within a range that does not inhibit the effects of the present disclosure. For example, as inorganic particles, a white pigment (more specifically, a titanium oxide particle, zinc oxide, zinc flower, zinc sulfide, white lead, and lithopone, etc.) and an extender pigment (more specifically, alumina, calcium carbonate, and barium sulfate, etc.) may be included. Other organic particles include, for example, a fluoropolymer particle, a benzoguanamine resin particle, and a styrene resin particle.

The number average primary particle size of the titanium oxide particle is favorably 100 nm or less, more favorably 1 nm or more and 50 nm or less.

### (Charge Generating Layer 4a)

The charge generating layer 4a includes a charge generating agent and has a function of generating charges upon light reception. The charge generating layer 4a may include a base resin, an additive, and a radical acceptor compound, as necessary.

Examples of the charge generating agent include a phthalocyanine pigment, a perylene pigment, a bisazo pigment, a trisazo pigment, a dithioketopyrrolopyrrole pigment, a metal-free naphthalocyanine pigment, a metal naphthalocyanine pigment, a squaraine pigment, an indigo pigment, an azulenium pigment, a cyanine pigment, a powder of an inorganic photoconductive material (e.g., selenium, selenium-tellurium, selenium-arsenic, cadmium sulfide, and amorphous silicon), a pyrylium pigment, an anthanthron pigment, a triphenylmethane pigment, a threne pigment, a toluidine pigment, a pyrazoline pigment, and a quinacridone pigment.

The phthalocyanine pigment has a phthalocyanine structure. Examples of the phthalocyanine pigment include metal phthalocyanine and metal-free phthalocyanine. Examples of the metal phthalocyanine include titanyl phthalocyanine, hydroxygallium phthalocyanine, and chlorogallium phthalocyanine. As the metal phthalocyanine, titanyl phthalocyanine is favorable. The titanyl phthalocyanine is represented by the following formula (CG-1). The metal-free phthalocyanine is represented by the following formula (CG-2).

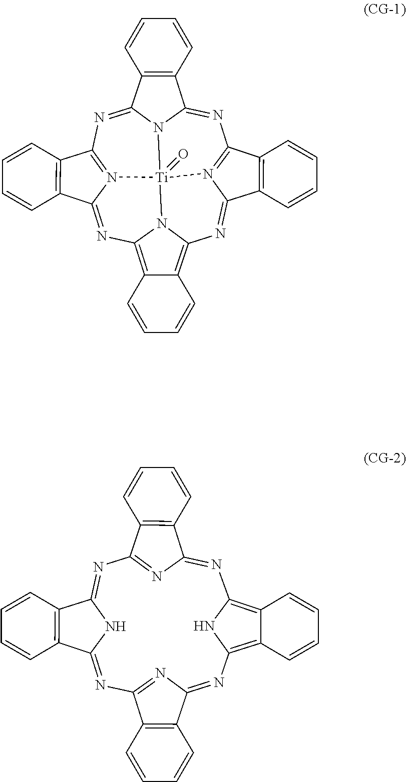

The phthalocyanine pigment may be crystalline or non-crystalline. Examples of the crystal of the metal-free phthalocyanine include an X-type crystal of the metal-free phthalocyanine (hereinafter, referred to as an X-type metal-free phthalocyanine in some cases). Examples of the crystal of the titanyl phthalocyanine include α-type, β-type, and γ-type crystals of the titanyl phthalocyanine (hereinafter, respectively referred to as α-type, β-type, and γ-type titanyl phthalocyanines in some cases).

For example, for a digital optical image forming apparatus (e.g., a laser beam printer or a facsimile machine using a light source such as semiconductor laser light), it is favorable to use a photoreceptor having sensitivity in a wavelength region of 700 nm or more. As the charge generating agent, a phthalocyanine pigment is favorable, titanyl phthalocyanine or metal-free phthalocyanine is more favorable, and γ-type titanyl phthalocyanine or X-type metal-free phthalocyanine is particularly favorable because they have a high quantum yield in the wavelength region of 700 nm or more.

The γ-type titanyl phthalocyanine has a main peak at, for example, 27.2° of the Bragg angle (2θ±0.2°) in the CuKα characteristic X-ray diffraction spectrum. The main peak in the CuKα characteristic X-ray diffraction spectrum is a peak having the first or second highest intensity in the range of the Bragg angle (2θ±0.2°) of 3° or more and 40° or less. The γ-type titanyl phthalocyanine does not have a peak at 26.2° in the CuKα characteristic X-ray diffraction spectrum.

The CuKα characteristic X-ray diffraction spectrum can be measured by, for example, the following method. First, a sample holder of an X-ray diffractometer (e.g., “RINT (registered trademark) 1100” manufactured by Rigaku Holdings Corporation and its Global Subsidiaries) is filled with a sample (titanyl phthalocyanine) to measure the X-ray diffraction spectrum under the conditions of an X-ray tube Cu, a tube voltage of 40 kV, a tube current of 30 mA, and a wavelength of CuKα characteristic X-rays of 1.542 Å. The measurement range (2θ) is, for example, 3° or more and 40° or less (start angle of 3°, stop angle of) 40°, and the scanning speed is, for example, 10°/min. The main peak is determined from the obtained X-ray diffraction spectrum, and the Bragg angle of the main peak is read.

### Base Resin

The charge generating layer may include a base resin. Examples of the base resin included in the charge generating layer are not particularly limited, but may be the same as the examples of the binder resin included in the charge transporting layer. However, in order to suitably form a charge generating layer and a charge transporting layer, it is favorable to select, as a base resin, a resin different from the resin used as the binder resin, of the above examples of the binder resin.

### Additive

Examples of the additive included in the photosensitive layer include an ultraviolet absorber, an antioxidant, a radical scavenger, a singlet quencher, a softener, a surface modifier, a bulking agent, a thickener, a dispersion stabilizer, a wax, a donor, a surfactant, a plasticizer, a sensitizer, an electron acceptor compound, and a leveling agent. Examples of the leveling agent include silicone oil, more specifically, dimethylsilicone oil.

The thickness of the charge generating layer 4a is not particularly limited, but is favorably 0.01 μm or more and 5 μm or less, more favorably 0.1 μm or more and 3 μm or less. Although the charge generating layer 4a is a single layer in the example shown in FIG. 1, the charge generating layer 4a may include a plurality of layers.

### (Charge Transporting Layer 4b)

The charge transporting layer 4b may include an additive and a radical acceptor compound as necessary, in addition to the binder resin and the hole transporting agent. The base resin, the additive, and the radical acceptor compound may be the same as those described above.

### Binder Resin

The binder resin includes at least one of (1) a polycarbonate resin (hereinafter, also referred to simply as a “PC resin”) or (2) a polyarylate resin (hereinafter, also referred to simply as a “PA resin”) as a main component. That is, the binder resin may be included as a homopolymer of the PC resin, a homopolymer of the PA resin, or a mixture of the PC resin and the PA resin. The binder resin according to the present disclosure favorably includes the PC resin. By using at least one of the PC resin or the PA resin, it is possible to exhibit the synergistic effect with the undercoat layer without impairing the effects of the specific hole transporting agent.

### (1) PC Resin

The PC resin is favorably a polycarbonate resin (PC1) that includes at least one of repeating units represented by the following formulae (20A) and (20B) (hereinafter, also referred to simply as a “repeating unit (20A)” and a “repeating unit (20B)”).

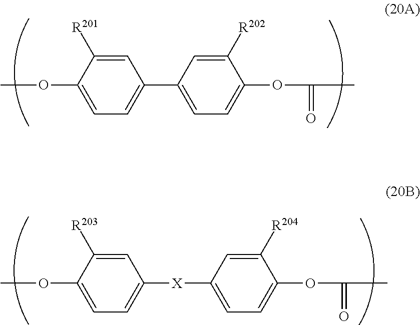

In the formula (20A), R²⁰¹ and R²⁰² each independently represent a hydrogen atom or an alkyl group having 1 or more and 4 or less carbon atoms, and in the formula (20B), R²⁰³ and R²⁰⁴ each independently represent a hydrogen atom or an alkyl group having 1 or more and 4 or less carbon atoms and X represents a divalent group represented by the following formula (X1) or (X2).

R²⁰¹ and R²⁰² each independently represent favorably a hydrogen atom or a methyl group, more favorably a hydrogen atom. R²⁰³ and R²⁰⁴ each independently represent a hydrogen atom, or an alkyl group having 1 or more and 4 or less carbon atoms, favorably a hydrogen atom or a methyl group, more favorably a hydrogen atom. X favorably represents the divalent group represented by the formula (X1) from the viewpoint of suppressing fog more effectively.

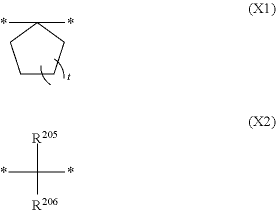

In the formula (X1), t represent an integer of 1 or more and 3 or less and * represents atomic bonding, and in the formula (X2), R²⁰⁵ and R²⁰⁶ each independently represent a hydrogen atom or an alkyl group having 1 or more and 4 or less carbon atoms and * represents atomic bonding. t favorably represents 1.

In particular, the PC resin favorably includes a repeating unit represented by the following formula (20B-1) (hereinafter, also referred to simply as a “repeating unit (20B-1)”) from the viewpoint of wear resistance.

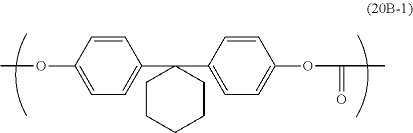

Further, the terminal group favorably includes a group represented by the following formula (T1). Hereinafter, this terminal group will also be referred to simply as a terminal group (T1).

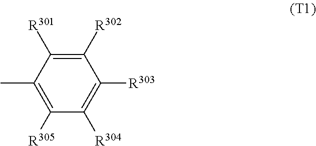

In the general formula (T1), R³⁰¹, R³⁰², R³⁰³, R³⁰⁴, and R³⁰⁵ each independently represent a hydrogen atom, an alkyl group having 1 to 20 carbon atoms, an alkoxy group having 1 to 20 carbon atoms, an alkoxy carbonyl group having 1 to 20 carbon atoms, or an aryl group having 6 or more and 14 or less carbon atoms, and at least one of R³⁰¹, R³⁰², R³⁰³, R³⁰⁴, or R³⁰⁵ represents the alkyl group having 1 to 20 carbon atoms, the alkoxy group having 1 to 20 carbon atoms, the alkoxy carbonyl group having 1 to 20 carbon atoms, or the aryl group having 6 or more and 14 or less carbon atoms.

Examples of the alkyl group having 1 to 20 carbon atoms include a methyl group, an ethyl group, an n-propyl group, an isopropyl group, an n-butyl group, a sec-butyl group, a tert-butyl group, an n-pentyl group, an isopentyl group, a neopentyl group, a 1,2-dimethylpropyl group, a hexyl group, a heptyl group, and an octyl group, each of which may be linear or branched chain and is unsubstituted.

Examples of the alkoxy group having 1 to 20 carbon atoms include a methoxy group, an ethoxy group, a propoxy group, a butoxy group, a pentyloxy group, a hexyloxy group, a heptyloxy group, an octyloxy group, a nonyloxy group, and a decyloxy group, each of which may be linear or branched and is unsubstituted.

The alkoxy carbonyl group having 1 to 20 carbon atoms is a group in which a linear or branched chain and unsubstituted alkoxy group having 1 to 20 carbon atoms is bonded to a carbonyl group.

The aryl group having 6 or more and 14 or less carbon atoms is, for example, an unsubstituted monocyclic aromatic hydrocarbon group having 6 to 14 carbon atoms, an unsubstituted aromatic condensed bicyclic hydrocarbon group having 6 to 14 carbon atoms, or an unsubstituted aromatic condensed tricyclic hydrocarbon group having 6 to 14 carbon atoms. Examples of the aryl group having 6 or more and 14 or less carbon atoms include a phenyl group, a naphthyl group, an anthryl group, and a phenanthryl group.

In the general formula (T1), R³⁰¹, R³⁰², R³⁰³, R³⁰⁴, and R³⁰⁵ each independently represent favorably a hydrogen atom or an alkyl group having 1 to 20 carbon atoms, more favorably t-butyl. Specifically, the terminal group particularly favorably includes a 4-(t-butyl) phenyl group.

In particular, the terminal group particularly favorably includes a group represented by the following formula (T2). Hereinafter, this terminal group will also be referred to simply as a terminal group (T2).

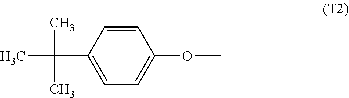

Favorable examples of the polycarbonate resin (PC1) include a polycarbonate resin including the repeating unit (20B-1) and the terminal group (T2), and a polycarbonate resin including a repeating unit (20A-1), the repeating unit (20B-1), and the terminal group (T2). The polycarbonate resin (PC1) is more favorably a polycarbonate resin represented by the following formula (PC1-1) (hereinafter, also referred to simply as a polycarbonate resin (PC1-1)), still more favorably a polycarbonate resin represented by the following formula (PC1-1-T) (hereinafter, also referred to as a polycarbonate resin (PC1-1-T)).

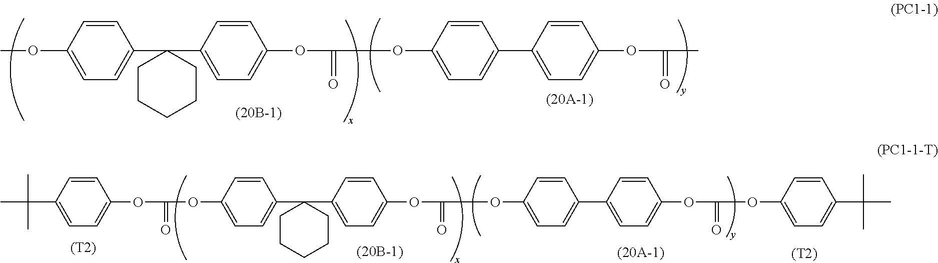

In the formula (PC1-1) and the formula (PC1-1-T), x at the bottom right of the repeating unit (20B-1) indicates the content ratio (unit: mol %) of the repeating unit (20B-1) to the total number of repeating units (20A-1) and repeating units (20B-1) included in the polycarbonate resin (PC1-1), and y at the bottom right of the repeating unit (20A-1) indicates the content ratio (unit: mol %) of the repeating unit (20A-1) to the total number of repeating units (20A-1) and repeating units (20B-1) included in the polycarbonate resin (PC1-1). The content ratio (x) of the repeating unit (20B-1) is favorably larger than 0 mol %. It is more favorable that the content ratio (x) of the repeating unit (20B-1) is 80 mol % or more and 90 mol % or less, and the content ratio (y) of the repeating unit (20A-1) is 10 mol % or more and 20 mol % or less.

The polycarbonate resin (PC1) may have a siloxane bond “—Si—O—”. An example of the polycarbonate resin (PC1) having a siloxane bond is a polycarbonate resin (PC1-S) having the siloxane bond “—Si—O—” in its main chain. Such a polycarbonate resin has, for example, its main chain incorporated with a repeating unit having a siloxane bond. As the polycarbonate resin having a siloxane bond in its main chain, a polycarbonate resin having a bond represented by the formula “—Si(CH₃)₂—O—” in its main chain is favorable, a polycarbonate resin including a repeating unit represented by the formula (20C) is more favorable, a polycarbonate resin including repeating units represented by the formulae (20C), (20A-1), and (20B-1) is still more favorable, and a polycarbonate resin including repeating units represented by the formulae (20C), (20A-1), and (20B-1) and a terminal group having a group represented by the formulae (T1) is particularly favorable. As the repeating unit (20C), the repeating unit (20C-1) is favorable. As the terminal group (T1), the terminal group (T2) is favorable.

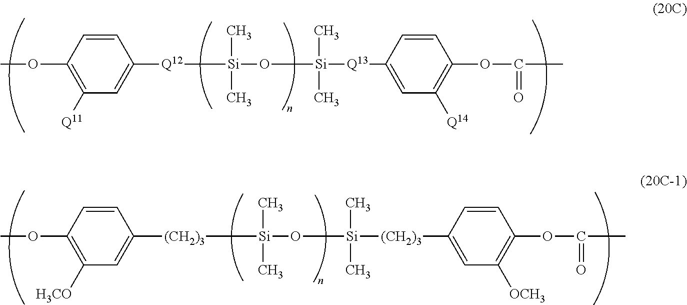

In the formula (20C), Q¹¹ and Q¹⁴ each independently represent an alkoxy group having 1 or more and 6 or less carbon atoms or an alkyl group having 1 or more and 6 or less carbon atoms. Q¹¹ and Q¹⁴ represent favorably an alkoxy group having 1 or more and 6 or less carbon atoms, more favorably an alkoxy group having 1 or more and 3 or less carbon atoms, still more favorably a methoxy group. In the formula (20C), Q¹² and Q¹³ each independently represent an alkanediyl group having 1 to 6 carbon atoms. Q¹² and Q¹³ represent favorably an alkanediyl group having 2 to 4 carbon atoms, more favorably a propanediyl group. n in the formulae (20C) and (20C-1) represents an integer of 30 or more and 60 or less.

In the polycarbonate resin (PC1-S), the content ratio of the repeating unit represented by the formula (20C) to the total number of repeating units included in the polycarbonate resin is favorably 0.05 mol % or more and 0.65 mol % or less. The content ratio of the repeating unit represented by the formula (20A-1) to the total number of repeating units included in the polycarbonate resin is favorably 10 mol % or more and 20 mol % or less. The content ratio of the repeating units represented by the formula (20B-1) to the total number of repeating units included in the polycarbonate resin is favorably 80 mol % or more and 90 mol % or less.

### (2) PA Resin

The PA resin is not particularly limited, but is favorably formed of, for example, a polyarylate resin (PA1) including a repeating unit represented by the following formula (40) (hereinafter, also referred to as a repeating unit (40)).

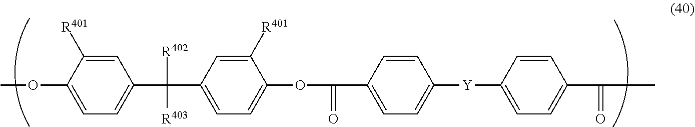

In the formula (40), R⁴⁰¹ represents a hydrogen atom or an alkyl group having 1 or more and 4 or less carbon atoms. R⁴⁰² and R⁴⁰³ each independently represent a hydrogen atom or an alkyl group having 1 or more and 4 or less carbon atoms, and Y represents a single bond or an oxygen atom.

The two R⁴⁰¹ may be the same as or different from each other. R⁴⁰² and R⁴⁰³ may be the same as or different from each other, and may be bonded together to form a ring, resulting in a cycloalkylidene group. R⁴⁰¹ favorably represents a hydrogen atom or a methyl group.

### (3) Other Resins

The binder resin may include a resin other than the PA resin and the PC resin as necessary, within a range that does not inhibit the effects of the present disclosure. The resin other than the polycarbonate resin (PC1) and the polyarylate resin (PA1) is not particularly limited as long as it can be used as a binder resin included in a photosensitive layer of an electrophotographic photoreceptor. Specific examples of such a resin include a thermoplastic resin such as a styrene resin, a styrene-butadiene copolymer, a styrene-acrylonitrile copolymer, a styrene-maleic acid copolymer, a styrene-acrylic acid copolymer, an acrylic copolymer, a polyethylene resin, an ethylene-vinyl acetate copolymer, a chlorinated polyethylene resin, a polyvinyl chloride resin, a polypropylene resin, an ionomer, a vinyl chloride-vinyl acetate copolymer, an alkyd resin, a polyamide resin, a polyurethane resin, a diallylphthalate resin, a ketone resin, a polyvinylbutyral resin, a polyether resin, and a polyester resin; a thermosetting resin such as a silicone resin, an epoxy resin, a phenolic resin, a urea resin, a melamine resin, and another cross-linkable thermosetting resin; and a photocurable resin such as an epoxyacrylate resin, and a urethane-acrylate copolymer resin. Two or more of these resins may be used in combination.

The content of the polycarbonate resin (PC1) including at least one of the repeating units (20A) and (20B) in the binder resin is not particularly limited as long as it does not hinder the purpose of the present disclosure. However, the content of the polycarbonate resin (PC1) including at least one of the repeating units (20A) and (20B) in the binder resin is favorably 60 mass % or more, more favorably 80 mass % or more, still more favorably 90 mass % or more.

Similarly, the content of the polyarylate resin (PA1) including the repeating unit (40) is not particularly limited as long as it does not hinder the purpose of the present disclosure. However, the content of the polyarylate resin (PA1) including the repeating unit (40) in the binder resin is favorably 60 mass % or more, more favorably 80 mass % or more, still more favorably 90 mass % or more.

Further, the total content of the polycarbonate resin (PC1) and the polyarylate resin (PA1) in the binder resin may be 60 mass % or more, 80 mass % or more, or 90 mass % or more.

### Hole Transporting Agent

In the compound represented by the general formula (1) included in the hole transporting agent, it is favorable that a1 represents an integer of 1 when R¹ represents a group represented by the formula (I), formula (II), or formula (III), a2 represents an integer of 1 when R² represents a group represented by the formula (I), formula (II), or formula (III), and a3 represents an integer of 1 when R³ represents a group represented by the formula (I), formula (II), or formula (III), from the viewpoint of achieving more favorable charge stability of the toner.

Note that when a1 represents an integer of 2 or more and 5 or less in the general formula (1), a plurality of R¹ may represent the same group or different groups. When a2 represents an integer of 2 or more and 5 or less, a plurality of R² may represent the same group or different groups. When a3 represents an integer of 2 or more and 5 or less, a plurality of R³ may represent the same group or different groups.

Further, in Ry of the group represented by the formula (III), the “phenyl group which may be substituted with an alkyl group having 1 to 8 carbon atoms” refers to that some or all of the hydrogen atoms in the phenyl group may be substituted with an alkyl group having 1 to 8 carbon atoms. Similarly, the “phenyl group which may be substituted with an alkoxy group having 1 to 8 carbon atoms” refers to that some or all of the hydrogen atoms in the phenyl group may be substituted with an alkoxy group having 1 to 8 carbon atoms. That is, the phenyl group may be one substituted with one or more substituent groups (C1 to C8 alkyl groups or C1 to C8 alkoxy groups).

As the compound represented by the general formula (1) (triphenylamine derivative), at least one selected from the group consisting of compounds represented by the following general formulae (1-1), (1-2), and (1-3) is favorable from the viewpoints of achieving a stable surface potential.

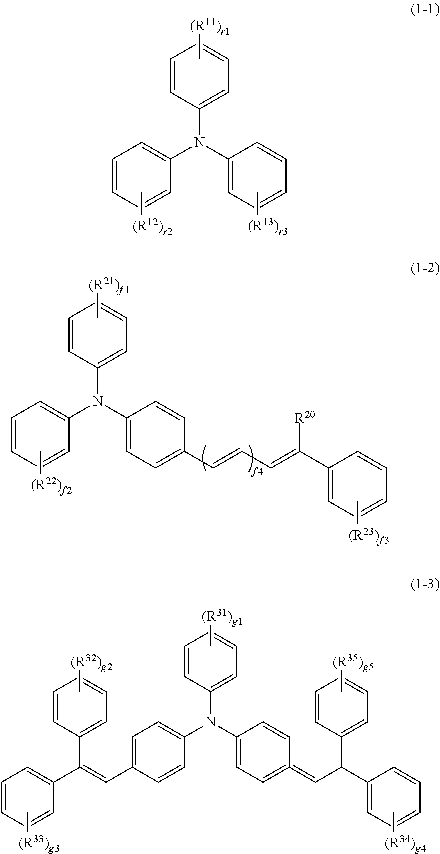

In the formula (1-1), R¹¹, R¹², and R¹³ each independently represent an alkyl group having 1 to 8 carbon atoms or an alkoxy group having 1 to 8 carbon atoms, and r1, r2, and r3 each independently represent an integer of 0 or more and 5 or less.

In the formula (1-1), when r1 represents an integer of 2 or more and 5 or less, a plurality of R¹¹ may represent the same group or different groups. When r2 represents an integer of 2 or more and 5 or less, a plurality of R¹² may represent the same group or different groups. When r3 represents an integer of 2 or more and 5 or less, a plurality of R¹³ may represent the same group or different groups.

In the formula (1-1), R¹¹, R¹², and R¹³ each independently represent favorably an alkyl group having 1 to 8 carbon atoms, more favorably an alkyl group having 1 or more and 6 or less carbon atoms, still more favorably an alkyl group having 1 or more and 3 or less carbon atoms, particularly favorably a methyl group. r1, r2, and r3 each independently represent favorably 0 or 1, more favorably 1.

In the formula (1-2), R²⁰ represents a hydrogen atom, an alkyl group having 1 to 8 carbon atoms, an alkoxy group having 1 to 8 carbon atoms, or a phenyl group which may be substituted with an alkyl group having 1 to 8 carbon atoms, R²¹, R²², and R²³ each independently represent an alkyl group having 1 to 8 carbon atoms or an alkoxy group having 1 to 8 carbon atoms, f1, f2, and f3 each independently represent an integer of 0 or more and 5 or less, and, f4 represents 0 or 1.

In the general formula (1-2), when f1 represents an integer of 2 or more and 5 or less, a plurality of R²¹ may represent the same group or different groups. When f2 represents an integer of 2 or more and 5 or less, a plurality of R²² may represent the same group or different groups. When f3 represents an integer of 2 or more and 5 or less, a plurality of R²³ may represent the same group or different groups.

In the general formula (1-2), R²⁰ favorably represents a phenyl group. R²¹, R²², and R²³ each independently represent favorably an alkyl group having 1 to 8 carbon atoms, more favorably an alkyl group having 1 or more and 3 or less carbon atoms, still more favorably a methyl group. f1 and f2 favorably represent 1. f3 favorably represents 0. As described above, f4 represents 0 or 1.

In the formula (1-3), R³¹, R³², R³³, R³⁴, and R³⁵ each independently represent an alkyl group having 1 to 8 carbon atoms or an alkoxy group having 1 to 8 carbon atoms, and g1, g2, g3, g4, and g5 each independently represent an integer of 0 or more and 5 or less.

In the general formula (1-3), when g1 represents an integer of 2 or more and 5 or less, a plurality of R³¹ may represent the same group or different groups. When g2 represents an integer of 2 or more and 5 or less, a plurality of R³² may represent the same group or different groups. When g3 represents an integer of 2 or more and 5 or less, a plurality of R³³ may represent the same group or different groups. When g4 represents an integer of 2 or more and 5 or less, a plurality of R³⁴ may represent the same group or different groups. When g5 represents an integer of 2 or more and 5 or less, a plurality of R³⁵ may represent the same group or different groups.

In the general formula (1-3), R³¹, R³², R³³, R³⁴, and R³⁵ each independently represent favorably an alkyl group having 1 to 8 carbon atoms, more favorably an alkyl group having 1 or more and 3 or less carbon atoms, still more favorably a methyl group. g1, g2, g3, g4, and g5 favorably represent 1.

The hole transporting agent is favorably at least one (e.g., one compound) of compounds represented by the following chemical formulae (HTM-1) to (HTM-4). Hereinafter, the compounds represented by the chemical formulae (HTM-1) to (HTM-4) will be referred to as hole transporting agents (HTM-1) to (HTM-4) in some cases.

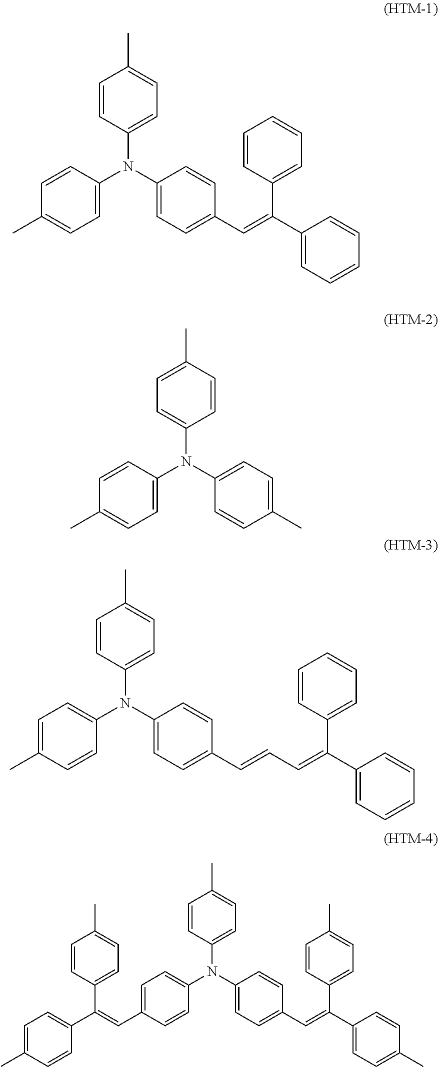

The content of the hole transporting agent is favorably 10 parts by mass or more and 200 parts by mass or less, more favorably 50 parts by mass or more and 100 parts by mass or less, with respect to 100 parts by mass of the binder resin.

The content of the compound represented by the general formula (1) with respect to the total mass of the hole transporting agent is favorably 80 mass % or more, more favorably 90 mass % or more, still more favorably 100 mass %.

The thickness of the charge transporting layer 4b is not particularly limited, but is favorably 2 μm or more and 100 μm or less, more favorably 5 μm or more and 50 μm or less. Although the charge transporting layer 4b is a single layer in the example shown in FIG. 1, the charge transporting layer 4b may include a plurality of layers.

### Second Embodiment: Image Forming Apparatus

An image forming apparatus including the photoreceptor 1 according to this embodiment will be described below. The image forming apparatus includes an image carrier (photoreceptor 1 according to this embodiment), a charging device, an exposure device, a development device, and a transfer device. The charging device charges the surface of the photoreceptor to positive polarity. The exposure device exposes the charged surface of the photoreceptor to form an electrostatic latent image on the surface of the photoreceptor. The development device supplies a toner to the electrostatic latent image to develop the electrostatic latent image as a toner image. The transfer device transfers the toner image from the photoreceptor to a to-be-transferred body.

In the following, as an aspect of the image forming apparatus including the photoreceptor 1 according to this embodiment, a color image forming apparatus employing a tandem method and a direct transfer method will be described with reference to FIG. 2.

An image forming apparatus 100 includes image forming units 40a, 40b, 40c, and 40d, a transfer belt 50, and a fixing unit 52. Hereinafter, in the case where there is no need to distinguish between the image forming units 40a, 40b, 40c, and 40d, each of them will be referred to as an image forming unit 40.

The image forming unit 40 includes an image carrier 30 (photoreceptor 1), a charging device 42, an exposure device 44, a development device 46, and a transfer device 48. The image carrier 30 is provided at the center position of the image forming unit 40. The image carrier 30 is provided to be rotatable in the direction indicated by an arrow (counterclockwise). Around the image carrier 30, the charging device 42, the exposure device 44, the development device 46, and the transfer device 48 are provided in the described order from the upstream side relative to the rotation direction of the image carrier 30.

Note that the image forming unit 40 may be further provided with one or both of a cleaning unit (not shown) and a static elimination unit (not shown). In the case where the image forming unit 40 is provided with a cleaning unit and a static elimination unit, the charging device 42, the exposure device 44, the development device 46, the transfer device 48, the cleaning unit, and the static elimination unit are provided around the image carrier 30 in the described order from the upstream side relative to the rotation direction of the image carrier 30.

The charging device 42 charges the surface (circumferential surface) of the image carrier 30. The charging device 42 uniformly charges the image carrier 30 to predetermined polarity by electric discharge. The charging device 42 is, for example, a charging roller.

The exposure device 44 exposes the charged surface 30a (1a) of the image carrier 30 (photoreceptor 1). This forms an electrostatic latent image on the surface 30a of the image carrier 30. The electrostatic latent image is formed on the basis of the image data input to the image forming apparatus 100.

The development device 46 supplies a toner to the electrostatic latent image formed on the surface 30a of the image carrier 30. This develops the electrostatic latent image as a toner image. The image carrier 30 corresponds to an image carrier that carries a toner image. Details of the development device 46 will be described below.

The transfer device 48 transfers the toner image developed by the development device 46 from the surface of the image carrier 30 to a recording medium P. In the transfer device 48, when the toner image is transferred from the image carrier 30 to the recording medium P, the image carrier 30 is in contact with the recording medium P. That is, the image forming apparatus 100 employs a so-called direct transfer method. Examples of the transfer device 48 include a transfer roller.

Toner images of a plurality of colors (e.g., four colors of black, cyan, magenta, and yellow) are sequentially superimposed onto the transfer belt 50 by the image forming units 40a to 40d. The toner images of the plurality of colors superimposed on the transfer belt 50 are then collectively transferred to the recording medium P.

The image forming apparatus 100 may include a cleaning unit (not shown). Examples of the cleaning unit include a cleaning blade and a cleaning roller.

The fixing unit 52 heats and/or pressurizes the unfixed toner image transferred to the recording medium P by the transfer device 48. The fixing unit 52 is, for example, a heating roller and/or a pressure roller. By heating and/or pressurizing the toner image, the toner image is fixed onto the recording medium P. As a result, an image is formed on the recording medium P.

### (Development Device)

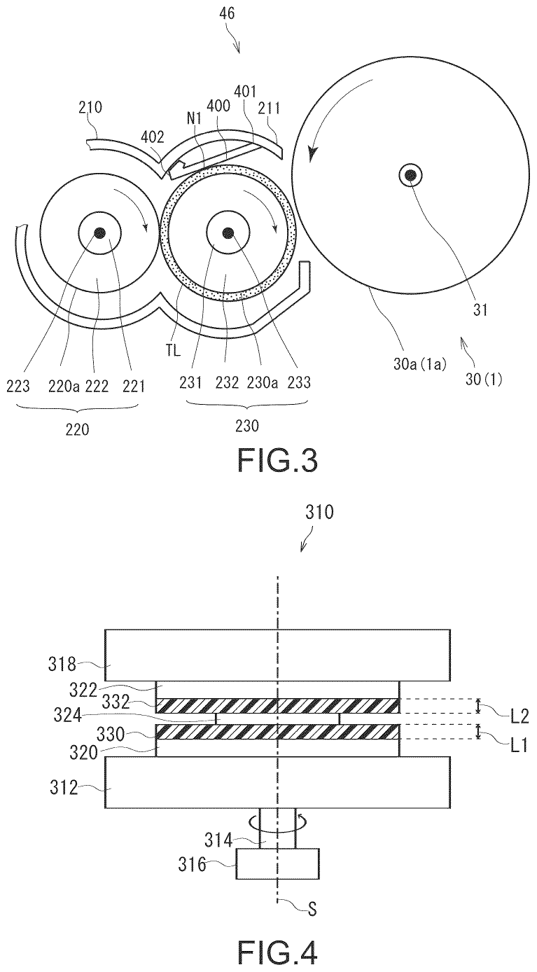

The development device 46 may employ a non-magnetic one-component development method. This allows the wear of the charge generating layer 4a of the photoreceptor 1 to be reduced. The development device 46 that employs a non-magnetic one-component development method will be described below with reference to FIG. 3. FIG. 3 is a diagram showing a partial configuration of the development device 46 shown in FIG. 2.

The development device 46 includes a housing frame 210, a supply roller 220, a development roller 230, and a regulating blade 400. The length of each of the supply roller 220 and the development roller 230 in the axial direction (direction orthogonal to the page of FIG. 3) is substantially the same as the length of the photoreceptor 1.

The housing frame 210 houses a non-magnetic one-component developer therein. The non-magnetic one-component developer corresponds to a toner. The toner does not include a magnetic powder. The housing frame 210 also houses the supply roller 220, the development roller 230, and the regulating blade 400 therein. The housing frame 210 has an opening 211 disposed to face the photoreceptor 1. The opening 211 exposes part of the development roller 230 to the outside of the housing frame 210.

The supply roller 220 is disposed inside the housing frame 210. The supply roller 220 is disposed to face the development roller 230. The supply roller 220 includes a supply roller shaft member 221 and a roller portion 222. The supply roller shaft member 221 is disposed to extend in the direction of a rotation shaft 223 of the supply roller 220. The supply roller shaft member 221 is rotatably supported on a shaft support portion (not shown) of the housing frame 210. The supply roller 220 is rotatable in the direction indicated by an arrow (clockwise). The roller portion 222 is a cylindrical member attached to the outside of the supply roller shaft member 221.

The supply roller 220 holds the toner that is the non-magnetic one-component developer housed inside the housing frame 210 on a surface 220a (circumferential surface) of the supply roller 220. In detail, the roller portion 222 rotates integrally with the supply roller shaft member 221 as the supply roller shaft member 221 rotates. The roller portion 222 holds the toner housed in the housing frame 210 on the outer peripheral surface of the roller portion 222. The outer peripheral surface of the roller portion 222 corresponds to the surface 220a of the supply roller 220. The supply roller 220 supplies the toner held on the surface 220a to the development roller 230.

The development roller 230 is disposed to face the photoreceptor 1. The development roller 230 is disposed to face the photoreceptor 1 via the opening 211 of the housing frame 210. Further, the development roller 230 is disposed to face the supply roller 220. The supply roller 220 is disposed to face the photoreceptor 1 via the development roller 230.

The development roller 230 includes a development roller shaft member 231 and a roller portion 232. The development roller shaft member 231 is disposed to extend in the direction of a rotation shaft 233 of the development roller 230. The development roller shaft member 231 is rotatably supported on a shaft support portion (not shown) of the housing frame 210. The development roller 230 is rotatable in the direction indicated by an arrow (clockwise). The development roller shaft member 231 includes one or more magnet portions (not shown). When the development roller shaft member 231 includes the one or more magnet portions, a predetermined gap is provided between the regulating blade 400 and a surface 230a of the development roller 230. The roller portion 232 is a cylindrical member attached to the outside of the development roller shaft member 231. The roller portion 232 rotates integrally with the development roller shaft member 231 as the development roller shaft member 231 rotates.

The development roller 230 is supplied with the toner from the supply roller 220. The toner supplied from the supply roller 220 is held on the surface 230a (circumferential surface) of the development roller 230 as a toner layer TL. The toner layer TL includes the toner supplied from the supply roller 220. The surface 230a of the development roller 230 corresponds to the surface of the roller portion 232. For example, the toner is held on the surface 230a of the development roller 230 by the mirror image force of the development roller 230.

The thickness of the toner layer TL held on the surface 230a of the development roller 230 is regulated by the regulating blade 400. Regulating the thickness of the toner layer TL means uniformly adjusting the thickness of the toner layer TL to a predetermined value.

The regulating blade 400 has a plate shape. The regulating blade 400 has one end 401 fixed to the housing frame 210 and the other end 402 being a free end. The other end 402 (free end) is formed by bending the outer edge of the plate-shaped member constituting the regulating blade 400 to the side opposite to the development roller 230 side.

The regulating blade 400 is disposed to abut on (specifically, be in surface contact with) the toner layer TL held on the surface 230a of the development roller 230. A regulating nip N1 is formed between the regulating blade 400 and the development roller 230.

The development roller shaft member 231 includes one or more magnet portions. Further, the regulating blade 400 is magnetic. Further, the regulating blade 400 is deflection-deformable such that the other end 402 side approaches the development roller 230 side. As a result, the other end 402 (free end) side of the regulating blade 400 is biased toward the development roller 230 by the biasing force generated by the magnetic force from the magnet portion. The regulating blade 400 then abuts on the toner layer TL held on the surface 230a of the development roller 230 with a predetermined pressure. In this way, the thickness of the toner layer TL held on the surface 230a of the development roller 230 can be regulated (uniformly adjusted to a predetermined value).

The regulating blade 400 is also deflection-deformable such that the other end 402 side moves away from the development roller 230. This allows the regulating blade 400 to smoothly guide the toner supplied from the supply roller 220 to the development roller 230 into the regulating nip N1.

The toner included in the toner layer TL becomes charged through friction caused by abutting on the regulating blade 400. The regulating blade 400 regulates the thickness of the toner layer TL and charges the toner included in the toner layer TL.

The photoreceptor 1 has, for example, a cylindrical shape. The photoreceptor 1 is rotatable in the direction indicated by an arrow (counterclockwise) about a rotation shaft 301 of the photoreceptor 1. The rotation shaft 301 of the photoreceptor 1 is orthogonal to the page of FIG. 3.

After the thickness of the toner layer TL is regulated by the regulating blade 400, the development roller 230 supplies the toner included in the toner layer TL held on the surface 230a to the electrostatic latent image formed on a surface 1a (circumferential surface) of the photoreceptor 1. This develops the electrostatic latent image as a toner image. In order to cause the toner to efficiently move from the surface 230a of the development roller 230 to the surface 1a of the photoreceptor 1, it is favorable to apply a developing bias. The development device 46 employing a one-component development method has been described above.

An example of the image forming apparatus 100 including the photoreceptor 1 according to this embodiment has been described above with reference to FIG. 2 and FIG. 3. Note that the image forming apparatus including the photoreceptor 1 according to this embodiment is not limited to the above-mentioned image forming apparatus 100. For example, the image forming apparatus may be a monochrome image forming apparatus. In this case, the image forming apparatus only needs to include, for example, one image forming unit. Further, although the above-mentioned image forming apparatus 100 is an image forming apparatus employing a tandem method, the image forming apparatus may employ, for example, a rotary method. Further, although the above-mentioned image forming apparatus 100 is an image forming apparatus employing a direct transfer method, the image forming apparatus may employ, for example, an intermediate transfer method.

### Third Embodiment: Process Cartridge

Subsequently, an example of a process cartridge including the photoreceptor 1 according to this embodiment will be described with reference to FIG. 2. The process cartridge is a cartridge for image formation. The process cartridge corresponds to each of the image forming units 40a to 40d. The process cartridge includes the photoreceptor 1 according to this embodiment. The process cartridge may further include, in addition to the photoreceptor 1, at least one selected from the group consisting of the charging device 42, the exposure device 44, the development device 46, and the transfer device 48. The process cartridge may be further provided with one or both of a cleaning unit (not shown) and a static elimination unit (not shown). The process cartridge may employ a no static elimination method. The process cartridge is designed to be attachable/detachable to/from the image forming apparatus 100. For this reason, the process cartridge is easy to handle and can be easily and quickly replaced, including the photoreceptor 1, when the sensitivity characteristics of the photoreceptor 1 deteriorate, for example. The process cartridge including the photoreceptor 1 according to this embodiment has been described above with reference to FIG. 2.

### Example

Although the present disclosure will be further specifically described below using Examples, the present disclosure is not limited to the scope of the Examples.

### (Binder Resin)

As binder resins used in the charge transporting layer, the following PC resins (R1) to (R4) were prepared.
PC resin (R1): a polycarbonate resin that is the polycarbonate resin (PC1-1-T) described in the embodiment in which the content ratio (x) of the repeating unit (20B-1) is 100 mol %.
PC resin (R2): a polycarbonate resin that is the polycarbonate resin (PC1-1-T) described in the embodiment in which the content ratio (y) and the content ratio (x) of the repeating units (20A-1) and (20B-1) are each 50 mol %.
PC resin (R3): a polycarbonate resin that is the polycarbonate resin (PC1-1-T) described in the embodiment in which the content ratio (y) of the repeating unit (20A-1) is 40 mol % and the content ratio (x) of the repeating unit (20B-1) is 60 mol %.
PC resin (R4): a polycarbonate resin that is the polycarbonate resin (PC1-S) having a siloxane bond in its main chain described in the embodiment, including the repeating units (20A-1), (20B-1), and (20C-1) and the terminal group (T2).

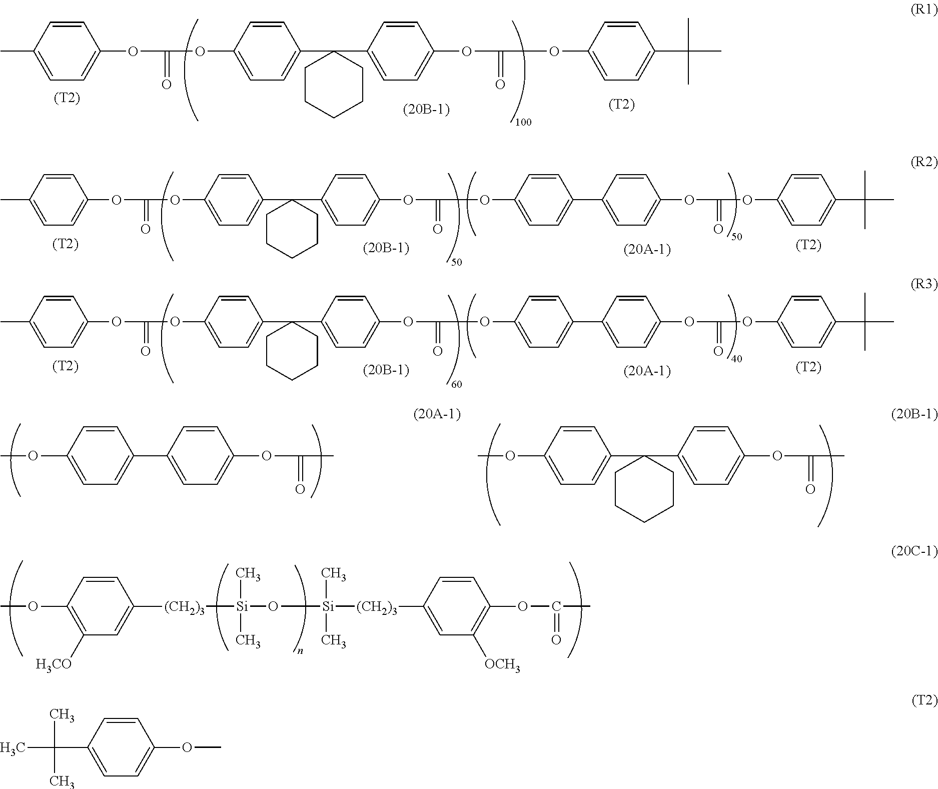

### (Hole Transporting Agent)

As hole transporting agents used in the charge transporting layer, the hole transporting agents (HTM-1) to (HTM-4) were used in Examples and the following hole transporting agents (HTM-5) to (HTM-8) were used in Comparative Examples.

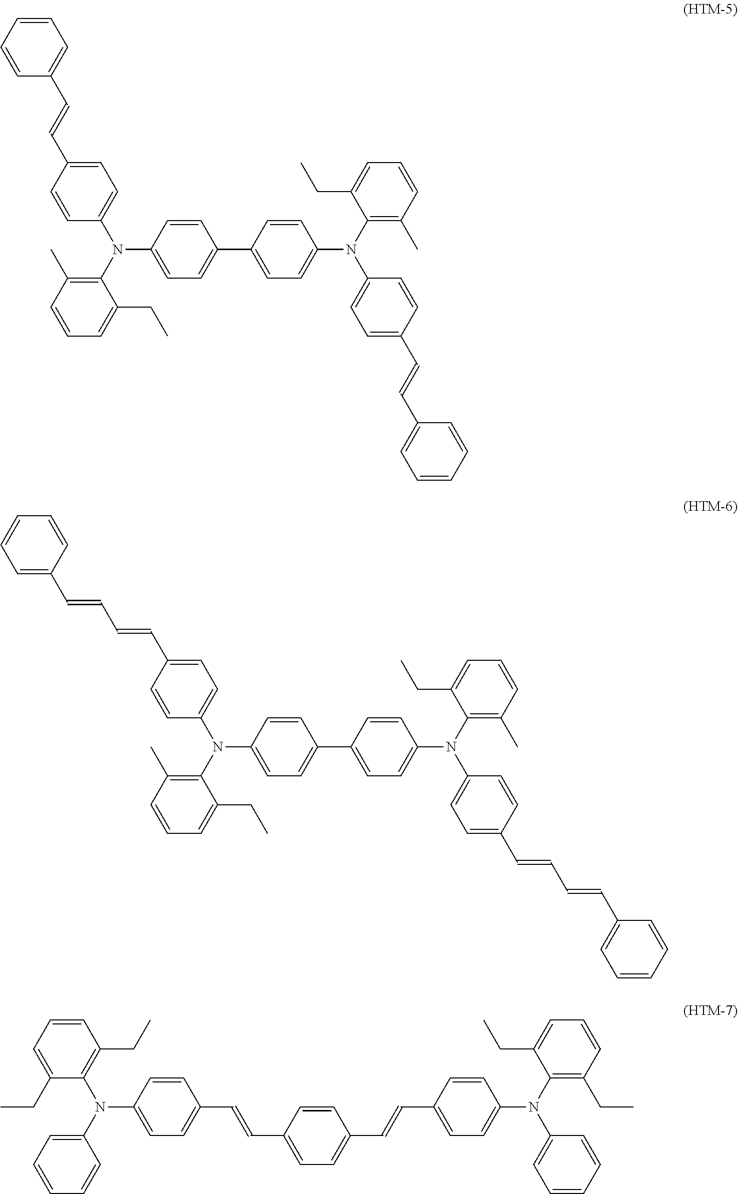 [SMILES: CCc1cccc(C)c1N(c1ccc(/C=C/c2ccccc2)cc1)c1ccc(-c2ccc(N(c3ccc(/C=C/c4ccccc4)cc3)c3c(C)cccc3CC)cc2)cc1 ; CCc1cccc(C)c1N(c1ccc(/C=C/C=C/c2ccccc2)cc1)c1ccc(-c2ccc(N(c3ccc(/C=C/C=C/c4ccccc4)cc3)c3c(C)cccc3CC)cc2)cc1 ; CCc1cccc(CC)c1N(c1ccccc1)c1ccc(/C=C/c2ccc(/C=C/c3ccc(N(c4ccccc4)c4c(CC)cccc4CC)cc3)cc2)cc1]

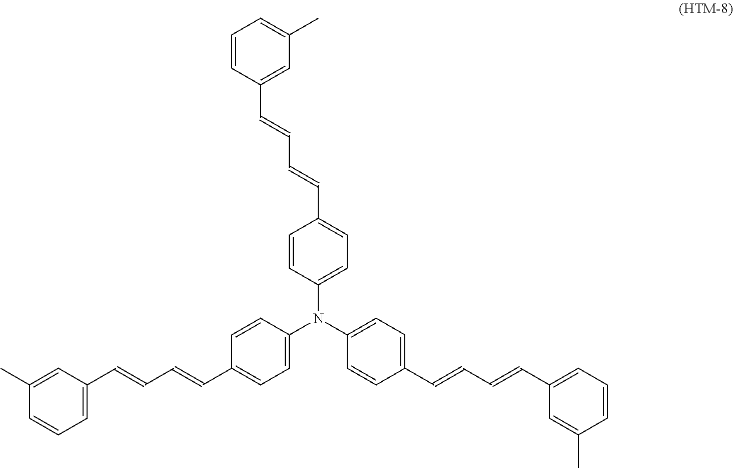 [SMILES: Cc1cccc(/C=C/C=C/c2ccc(N(c3ccc(/C=C/C=C/c4cccc(C)c4)cc3)c3ccc(/C=C/C=C/c4cccc(C)c4)cc3)cc2)c1]

### [Preparation of Electrophotographic Photoreceptor for Evaluation]

Electrophotographic photoreceptors according to Examples 1 to 7 and Comparative Examples 1 to 5 were produced by the following method. The configurations of these electrophotographic photoreceptors are shown in Table 1 described below.

### Example 1

In Example 1, an electrophotographic photoreceptor including an undercoat layer (U1), a PC resin (R¹), and a hole transporting agent (HTM-1) was prepared in the following procedure.

### Formation of Undercoat Layer (U1)

A mixture of 1.5 parts by weight of an oil-free alkyd resin (manufactured by DIC CORPORATION: BECKOLITE M6401), 1 part by weight of a melamine resin (manufactured by DIC CORPORATION: SUPER BECKAMINE G-821), 5 parts by weight of a titanium dioxide particle (manufactured by ISHIHARA SANGYO KAISHA, LTD.: TIPAQUE CR-EL), and 2.5 parts by weight of 2-butanone was placed in a ball mill pot, and ball milling was performed for 48 hours using a φ10 mm alumina ball, thereby preparing a coating liquid for an undercoat layer.

The obtained coating liquid for an undercoat layer was filtered with a 5 μm filter and then applied to an aluminum drum-shaped support having a diameter of 30 mm as a conductive support by a dip coating method, and heat treatment was performed at 150° C. for 30 minutes to form an undercoat layer having a film thickness of 2.0 μm.

### Formation of Charge Generating Layer

Next, 2.3 parts by weight of a Y-type titanyl phthalocyanine, 1 part by weight of a polyvinylacetal resin (manufactured by SEKISUI CHEMICAL CO., LTD., S-LEC BX-5) as a binder resin, and 40 parts by weight of propylene glycol monomethyl ether and 40 parts by weight of tetrahydrofuran as dispersion media were mixed and dispersed for 12 hours using a bead mill, thereby preparing a coating liquid for a charge generating layer. The obtained coating liquid was filtered with a 3 μm filter, then applied onto the undercoat layer prepared above by a dip coating method, and heated at 50° C. for 5 minutes to form a charge generating layer having a film thickness of 0.3 μm.

### Formation of Charge Transporting Layer

Next, 45 parts by weight of a compound represented by the formula (HTM-1) as a hole transporting agent, 100 parts by weight of a polycarbonate resin represented by the formula (R1) as a binder resin, 0.05 parts by weight of dimethylsilicone oil KF96-50CS as a leveling agent, and 560 parts by weight of tetrahydrofuran and 140 parts by weight of toluene as solvents were mixed to prepare a coating liquid for a charge transporting layer.

The prepared coating liquid for a charge transporting layer was applied onto the charge generating layer in the same manner as that for the coating liquid for a charge generating layer, and dried at 120° C. for 40 minutes to form a charge transporting layer having a film thickness of 25 μm, thereby preparing a stacked electrophotographic photoreceptor.

### Examples 2 to 4

In Examples 2 to 4, electrophotographic photoreceptors were prepared in the same manner as that in Example 1 except that the hole transporting agent (HTM-1) in the coating liquid for a charge transporting layer was replaced with the hole transporting agents (HTM-2), (HTM-3), and (HTM-4), respectively.

### Examples 5 to 7

In Examples 5 to 7, electrophotographic photoreceptors were prepared in the same manner as that in Example 1 except that the PC resin (R1) in the coating liquid for a charge transporting layer was replaced with the PC resins (R2), (R3), and (R4), respectively.

### Comparative Examples 1 to 4

In Comparative Examples 1 to 4, electrophotographic photoreceptors were prepared in the same manner as that in Example 1 except that the hole transporting agent (HTM-1) in the coating liquid for a charge transporting layer was replaced with the hole transporting agents (HTM-5) to (HTM-8), respectively.

### Comparative Example 5

Comparative Example 5, an electrophotographic photoreceptor was prepared in the same manner as that in Example 1 except that the undercoat layer (U1) was replaced with an undercoat layer (U2). The undercoat layer (U2) was formed as follows.

### Formation of Undercoat Layer (U2)

2 parts by mass of titanium oxide that has been subjected to surface treatment with alumina and silica and then surface treatment with methylhydrogenpolysiloxane while wet dispersing (“SMT-A” manufactured by TAYCA Co., Ltd., a number average primary particle size of 10 nm), 1 part by mass of a quaternary copolymerized polyamide resin of polyamide 6, polyamide 12, polyamide 66, and polyamide 610 (“Amilan CM8000” manufactured by TORAY INDUSTRIES, INC.), 10 parts by mass of methanol, 1 part by mass of butanol, and 1 part by mass of toluene were dispersed for 5 hours using a bead mill, thereby preparing a coating liquid for an undercoat layer. This was used to form the undercoat layer (U2).

### [Evaluation of Stacked Electrophotographic Photoreceptor]

For each stacked electrophotographic photoreceptor, a toner frictional charge amount, a charge retention rate, and fog density were measured and the toner's friction chargeability, charge retention, and fog were evaluated by the following method. The evaluation results are shown in Table 1.

### (1) Measurement of Toner Frictional Charge Amount

The charge amount of the toner when the photosensitive layer 4 and the toner were rubbed together (the frictional charge amount) was measured. FIG. 4 shows an overview of the measuring apparatus for the frictional charge amount. The frictional charge amount of the toner was measured by performing the following first step, second step, third step, and fourth step. A jig 310 was used to measure the frictional charge amount of the toner.

As shown in FIG. 4, the jig 310 includes a first base 312, a rotation shaft 314, a rotation drive unit 316 (e.g., a motor), and a second base 318. The rotation drive unit 316 causes the rotation shaft 314 to rotate. The rotation shaft 314 rotates about a rotation axis S of the rotation shaft 314. The first base 312 rotates integrally with the rotation shaft 314 with the rotation axis S as their center. The second base 318 is fixed without rotating.

### (First Step)

In the first step, two photosensitive layers were prepared. Hereinafter, one of the photosensitive layers will be referred to as a first photosensitive layer 330, and the other photosensitive layer will be referred to as a second photosensitive layer 332. The coating liquid for a stacked photosensitive layer prepared when preparing the above-mentioned stacked photoreceptor was applied to an overhead projector sheet (hereinafter, referred to as an OHP sheet in some cases) wound around an aluminum pipe (diameter: 78 mm). The applied coating liquid was dried at 120° C. for 80 minutes. In this way, a sheet for evaluating friction chargeability in which a photosensitive layer having a film thickness of 30 μm was formed was prepared. As a result, a first sheet including the first photosensitive layer 330 (film thickness L1: 30 μm) and a first OHP sheet 320, and a second sheet including the second photosensitive layer 332 (film thickness L2: 30 μm) and a second OHP sheet 322 were obtained. The dimensions of each of the first OHP sheet 320 and the second OHP sheet 322 were 5 cm long and 5 cm wide (Note that the coating liquid for a stacked photosensitive layer is used as a collective term for the coating liquid for an undercoat layer, the coating liquid for a charge generating layer, and the coating liquid for a charge transporting layer).

### (Second Step)

In the second step, 0.007 g of a toner was placed on the first photosensitive layer 330. The second photosensitive layer 332 was placed on a layer 324 of the toner. The specific procedure was as follows.

First, a toner degraded due to continuous printing was created using a color printer (“C844dnw” manufactured by Oki Electric Industry Co., Ltd.). A toner cartridge of the printer was filled with a cyan toner, and the stacked photoreceptor was mounted on the printer. Subsequently, under a normal temperature and normal humidity environment (a temperature of 23° C. and a relative humidity of 50% RH: thereinafter, referred to as an NN environment in some cases), an image I (pattern image with a coverage rate of 1%) was printed on 1,000 sheets of paper to create a degraded toner.

Subsequently, the first OHP sheet 320 was adhered to the first base 312 using double sided tape, fixing the first sheet to the first base 312. The second OHP sheet 322 was adhered to the second base 318 using double sided tape, fixing the second sheet to the second base 318. 0.007 g of the toner was placed on the first photosensitive layer 330 included in the first sheet to form the layer 324 of the toner such that the film thickness thereof is uniform. The amount of the toner is sufficient for the toner to be sufficiently and uniformly rubbed with the first photosensitive layer 330 and the second photosensitive layer 332 and for the toner to be sufficiently and uniformly charged during the rotation time of 60 seconds in the third step. The layer 324 of the toner is formed inside the first photosensitive layer 330 around the rotation axis S such that it does not fall out from between the first photosensitive layer 330 and the second photosensitive layer 332 due to the driving of the rotation drive unit 316 in the third step. The second photosensitive layer 332 and the layer 324 of the toner were brought into contact with each other to place the second photosensitive layer 332 on the layer 324 of the toner such that the first photosensitive layer 330 and the second photosensitive layer 332 face each other via the layer 324 of the toner. In this way, the first base 312, the first OHP sheet 320, the first photosensitive layer 330, the layer 324 of the toner, the second photosensitive layer 332, the second OHP sheet 322, and the second base 318 were arranged in this order from bottom to top. The centers of the first base 312, the first OHP sheet 320, the first photosensitive layer 330, the layer 324 of the toner, the second photosensitive layer 332, the second OHP sheet 322, and the second base 318 were positioned such that they passed through the rotation axis S.

### (Third Step)

In the third step, under an environment with a temperature of 23° C. and a humidity of 50% RH, the first photosensitive layer 330 was caused to rotate at a rotational speed of 60 rpm for 60 seconds while fixing the second photosensitive layer 332. Specifically, the rotation drive unit 316 was driven to cause the rotation shaft 314, the first base 312, the first OHP sheet 320, and the first photosensitive layer 330 to rotate at a rotational speed of 60 rpm for 60 seconds about the rotation axis S. In this way, the toner was rubbed with the first photosensitive layer 330 and the second photosensitive layer 332 and charged.

### (Fourth Step)

In the fourth step, the toner charged in the third step was removed from the jig 310, and sucked in using a charge amount measuring device (small suction-type charge amount measuring device, “MODEL 212HS” manufactured by TREK, INC.). The total electrical charge Q (unit: μC) and the mass M (unit: g) of the sucked toner were measured using the charge amount measuring device. The frictional charge amount (unit: μC/g) of the toner was calculated from the formula “frictional charge amount=Q/M”.

### (Evaluation of Friction Chargeability)

The frictional charge amount of the toner is shown in Table 1. Note that the larger the absolute value of the frictional charge amount of the toner, the more easily the toner becomes negatively charged relative to the first photosensitive layer 330 and the second photosensitive layer 332. A case where the absolute value of the frictional charge amount of the toner was greater than the absolute value of −15 μQ/g was evaluated as the toner's charge stability being achieved.

### (2) Measurement of Charge Retention Rate

An electrical property tester manufactured by GENTEC was used as an evaluation device for measuring the charge retention rate. The drum was charged under a high-temperature and high-humidity environment (a temperature of 32 degrees and a relative humidity of 80% RH) such that the surface potential became-600 V (V₀ₐ), and the surface potential after 5 seconds was measured (V_{0b}). The charge retention rate was calculated from the formula “charge retention rate (%)=(V_{0b}/V₀ₐ)*100”.

### (Evaluation of Charge Retention)

A case where the charge retention rate was 93% or more was evaluated as high charge retention being achieved in the photoreceptor.

### (3) Measurement of Fog Density

A color printer (“C844dnw” manufactured by Oki Electric Industry Co., Ltd.) was used as an evaluation device for measuring the fog density. The toner cartridge of the evaluation device was filled with a cyan toner, and the image I was printed on 2,000 sheets of paper using the above evaluation device under the HH environment. After leaving it for 12 hours under the HH environment, one blank sheet of paper was printed, and the toner adhered to the drum surface of the Unexposed portion was collected using Scotch Mending Tape (manufactured by 3M). The concentration of the collected toner was measured using a spectrodensitometer, and this was used as the fog density for fog evaluation.

### (Fog Evaluation)

Evaluation A (Particularly good) Fog density of 1.40 or less
Evaluation B (Good) Fog density of exceeding 1.40 and less than 1.61
Evaluation C (Poor) Fog density of 1.61 or more

TABLE 1

| | | Charge transporting layer | | Toner frictional | | Charge |
|---|---|---|---|---|---|---|
| | Undercoat | | Hole transporting | charge amount | | retention |
| | layer | Resin | agent | μQ/g | Fog | rate % |
| Example 1 | U1 | R1 | HTM-1 | −18.0 | A | 95.0 |
| Example 2 | U1 | R1 | HTM-2 | −18.5 | A | 95.5 |
| Example 3 | U1 | R1 | HTM-3 | −16.1 | A | 94.8 |
| Example 4 | U1 | R1 | HTM-4 | −15.2 | A | 93.2 |
| Example 5 | U1 | R2 | HTM-1 | −18.1 | A | 94.6 |
| Example 6 | U1 | R3 | HTM-1 | −15.3 | A | 94.5 |
| Example 7 | U1 | R4 | HTM-1 | −21.5 | A | 95.4 |
| Comparative Example 1 | U1 | R1 | HTM-5 | −12.0 | B | 94.2 |
| Comparative Example 2 | U1 | R1 | HTM-6 | −12.9 | B | 93.8 |
| Comparative Example 3 | U1 | R1 | HTM-7 | −14.9 | B | 94.5 |
| Comparative Example 4 | U1 | R1 | HTM-8 | −14.5 | B | 93.8 |
| Comparative Example 5 | U2 | R1 | HTM-1 | −17.9 | C | 90.1 |

As shown in Table 1, in all of the electrophotographic photoreceptors according to Examples 1 to 7, the toner frictional charge amount was −15 μQ/g or less, the charge retention rate of the photoreceptor was high, i.e., 93% or more, and the fog evaluation was A.

On the other hand, as shown in Table 1, in all of the electrophotographic photoreceptors according to Comparative Examples 1 to 4 in which the undercoat layer (U1) that was the same as that in the present disclosure was included but the charge transport agents (HTM-5) to (HTM-8) that were different from the hole transporting agent according to the present disclosure were used, the charge retention rate was 93% or more, but the absolute value of the toner frictional charge amount was smaller than the absolute value of −15 μQ/g and the fog evaluation was B. In Comparative Example 5 in which the undercoat layer (U2) that did not include an alkyd resin, a melamine resin, and a titanium dioxide particle was used, the charge retention rate was low, i.e., 93% or less and the fog evaluation was C although the absolute value of the toner frictional charge amount was larger than the absolute value of −15 μQ/g.

It should be understood by those skilled in the art that various modifications, combinations, sub-combinations and alterations may occur depending on design requirements and other factors insofar as they are within the scope of the appended claims or the equivalents thereof.

What is claimed is:

1. An electrophotographic photoreceptor that is used in an image forming apparatus using a non-magnetic one-component pulverized toner, comprising:
a conductive base;
an undercoat layer provided on the conductive base; and
a photosensitive layer provided on the undercoat layer,
the photosensitive layer including a charge generating layer and a charge transporting layer,
the undercoat layer including a thermosetting resin and a titanium oxide particle, the thermosetting resin including an alkyd resin and a melamine resin,
the charge transporting layer including a binder resin and a hole transporting agent, the binder resin including at least one of a polycarbonate resin or a polyarylate resin, the hole transporting agent including a compound represented by the following general formula (1): 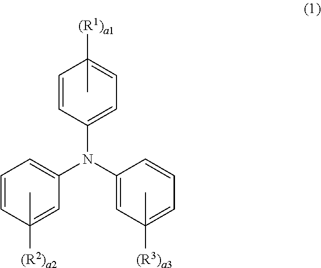
wherein, in the general formula (1), R¹, R², and R³ each independently represent an alkyl group having 1 to 8 carbon atoms, an alkoxy group having 1 to 8 carbon atoms, or a group represented by the following formula (I), formula (II), or formula (III), at least one or more of R¹, R², and R³ represent an alkyl group having 1 to 8 carbon atoms or an alkoxy group having 1 to 8 carbon atoms, and a1, a2, and a3 each independently represent an integer of 0 or more and 5 or less, 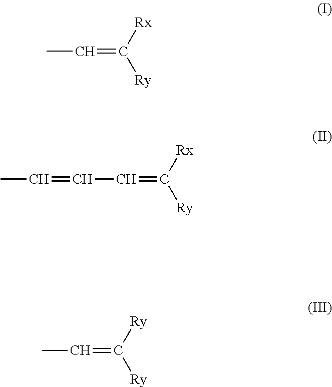
wherein, in the formula (I), the formula (II), and the formula (III), Rx each independently represent a hydrogen atom, an alkyl group having 1 to 8 carbon atoms, an alkoxy group having 1 to 8 carbon atoms, or a phenyl group which may be substituted with an alkyl group having 1 to 8 carbon atoms, and Ry each independently represent a phenyl group which may be substituted with an alkyl group having 1 to 8 carbon atoms or a phenyl group which may be substituted with an alkoxy group having 1 to 8 carbon atoms.

2. The electrophotographic photoreceptor according to claim 1, wherein
the compound represented by the general formula (1) is at least one selected from the group consisting of compounds represented by the following formulae (1-1), (1-2), and (1-3): 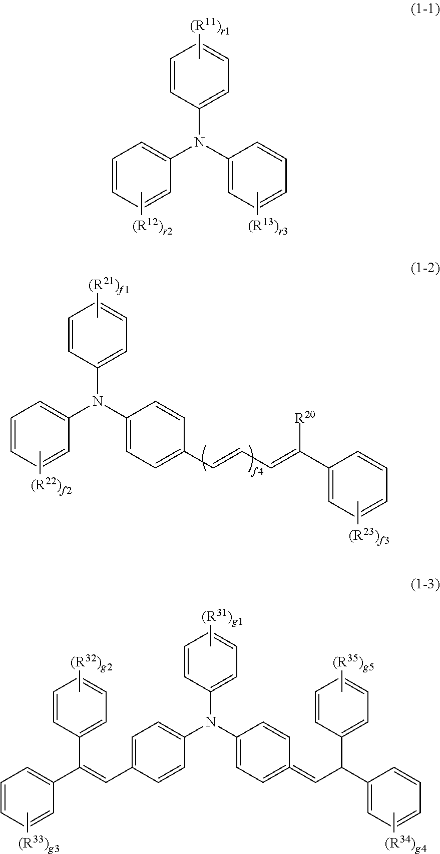
wherein, in the formula (1-1), R¹¹, R¹², and R¹³ each independently represent an alkyl group having 1 to 8 carbon atoms or an alkoxy group having 1 to 8 carbon atoms, and r1, r2, and r3 each independently represent an integer of 0 or more and 5 or less,
in the formula (1-2), R²⁰ represents a hydrogen atom, an alkyl group having 1 to 8 carbon atoms, an alkoxy group having 1 to 8 carbon atoms, or a phenyl group which may be substituted with an alkyl group having 1 to 8 carbon atoms, R²¹, R²², and R²³ each independently represent an alkyl group having 1 to 8 carbon atoms or an alkoxy group having 1 to 8 carbon atoms, f1, f2, and f3 each independently represent an integer of 0 or more and 5 or less, and f4 represents 0 or 1, and
in the formula (1-3), R³¹, R³², R³³, R³⁴, and R³⁵ each independently represent an alkyl group having 1 to 8 carbon atoms or an alkoxy group having 1 to 8 carbon atoms, and g1, g2, g3, g4, and g5 each independently represent an integer of 0 or more and 5 or less.

3. The electrophotographic photoreceptor according to claim 1, wherein the charge transporting layer is a top surface layer.

4. The electrophotographic photoreceptor according to claim 1, which is exposed by a light-emitting diode (LED).

5. The electrophotographic photoreceptor according to claim 1, which is used in an image forming apparatus employing a direct transfer method.

6. A process cartridge, comprising:
the electrophotographic photoreceptor according to claim 1.

7. An image forming apparatus, comprising:
an image carrier;
a charging device that charges a surface of the image carrier;
an exposure device that exposes the charged surface of the image carrier to form an electrostatic latent image on the surface of the image carrier;
a development device that supplies a toner to the surface of the image carrier to develop the electrostatic latent image as a toner image; and
a transfer device that transfers the toner image from the image carrier to a to-be-transferred body,
the image carrier being the electrophotographic photoreceptor according to claim 1.

8. The image forming apparatus according to claim 7, wherein
the development device includes a supply roller, a development roller, and a regulating blade,
the supply roller supplies the toner that is a non-magnetic one-component developer to the development roller,
the development roller holds a toner layer including the toner on a surface of the development roller,
the regulating blade regulates a thickness of the toner layer held on the surface of the development roller, and
the toner included in the toner layer whose thickness has been regulated is supplied from the surface of the development roller to the electrostatic latent image to develop the electrostatic latent image as the toner image.
